(19) United States
(12) Patent Application Publication
(10) Pub. No.: US 2017/0306170 A1
(43) Pub. Date: Oct. 26, 2017

(54) COMPOSITION COMPRISING NANOPARTICLES WITH DESIRED SINTERING AND MELTING POINT TEMPERATURES AND METHODS OF MAKING THEREOF

(71) Applicant: SDCmaterials, Inc., Tempe, AZ (US)

(72) Inventors: David LEAMON, Gilbert, AZ (US); Maximilian A. BIBERGER, Scottsdale, AZ (US)

(21) Appl. No.: 15/506,160

(22) PCT Filed: Aug. 28, 2015
(86) PCT No.: PCT/US2015/047537

§ 371 Date: Feb. 23, 2017

Related U.S. Application Data
(60) Provisional application No. 62/044,081, filed on Aug. 29, 2014.

(51) Int. Cl. C09D 11/037; C09D 11/52; B22F 1/00; B22F 9/12; C09D 17/00

(52) U.S. Cl. CPC C09D 11/037; B22F 1/0022; C09D 11/52; C09D 17/006; B22F 1/0018; B22F 9/12; B22F 1/0059; B22F 2304/054; B22F 2301/255

(57) ABSTRACT

Composite compositions comprising metal nanoparticles and/or microparticles and a binder are provided. Composites are tunable to achieved specific desired characteristics, such as sintering temperature, melting temperature, print resolution, and surface binding capabilities. Preferably, the metal particles may be produced using plasma-based technology. The composites are spreadable or printable and are especially useful in the field of electronics. The composites are capable of being used to form highly conductive wires or traces in electronic components. Preferably, the resulting metal structure has a low level of metal oxidation. The disclosure also includes methods for producing composite materials.

### CROSS-REFERENCE TO RELATED APPLICATIONS

This application claims priority benefit of U.S. Provisional Patent Application No. 62/044,081, filed Aug. 29, 2014. The entire contents of that application are hereby incorporated by reference herein.

### FIELD OF THE INVENTION

The present invention relates to materials, and more specifically, nanoparticles. More specifically, the present invention relates to the use of nanoparticles and/or microparticles to control characteristics of materials comprising metals, metal alloys, and/or binders, such as the sintering temperature, melting temperature, print resolution, and/or surface binding capabilities.

### BACKGROUND OF THE INVENTION

Metals, which for purposes of this discussion will include both single element metals and metal alloys, have long been used in electronics for conductive purposes. For example, conductive metals can be used to form wires or traces in electrical circuitry. To form such electrical components, metals must be deposited on a substrate, typically a non-conductive substrate. Further, said metals must be connected at the atomic level so as to allow for formation of one or more electrically conducting paths. Methods of connecting metals, such as those used to form circuitry, include sintering or melting metal to form sintered or melted metal structures.

The melting temperature is the temperature at which a solid metal changes state to a liquid metal. The sintering temperature of a metal is close to, but below, the melting point temperature, and is the temperature at which a particle, piece, and/or portion of said metal will bond to another particle, piece, and/or portion of a metal. Sintered metal structures formed under the proper conditions can have similar electrical properties as metal structures formed by melting.

Bulk metals, which can be in particle form, have characteristic sintering and melting point temperatures. Use of the term “bulk metal” refers to a metal particle at or above the critical particle size. At or above the critical particle size, bulk metal will have a particular sintering and melting point temperature irrespective of increasing particle size. Below a critical particle size, it is observed that said metal particle will have an increasingly lower sintering and/or melting temperature in relation to decreasing particle size. For example, the melting temperature for bulk copper is about 1085 degrees centigrade whereas the melting temperature for a 5 nanometer particle of cooper is approximately 80 degrees centigrade.

Deposition of metals onto substrates for use in electronics requires that the sintering and/or melting point temperature be compatible with other processing steps, such as those used in the semiconductor processing or electronics fabrication industry. For example, Kapton tape is often used to create flexible electronic assemblies. Kapton tape has a melting point at about 260 degrees centigrade, which is significantly lower than the bulk melting temperature of silver, about 962 degrees centigrade, and copper, about 1085 degrees centigrade.

An often desired electrical property of a sintered or melted metal structure is a low electrical resistance of the resulting metal structure. Electrical conductivity of metal structures, such as those in electrical circuitry, can be affected by the composition of metal(s) used and the presence of oxidation on or within said metal structure. For example, silver has the highest electrical conductivity of any element. Furthermore, to achieve a low electrical resistance, typically it is required that the sintering or melting of the metal is conducted in a low oxygen environment to prevent oxidization of the resulting metal structure.

There is a need in the art for a cost-efficient composition comprising metal that: (a) has a desired sintering or melting temperature that is compatible with electronic fabrications and semiconductor processing steps; (b) is highly conductive; (c) can be formed with a resulting low level of metal oxidation; and (d) can be produced in bulk quantities. The present disclosure provides compositions that meet these requirements, and methods of using said compositions.

### SUMMARY OF THE INVENTION

The present disclosure provides composite compositions, and methods of making thereof, that may be controllably tuned to have desired characteristics, such as sintering temperature, melting temperature, print resolution, and surface binding capabilities. The composites comprise metal particles and a binder. In some embodiments, a composite comprising metal nanoparticles may be formed. Preferably, the nanoparticles may be dispersed evenly throughout the binder composition. In some embodiments, a composite comprising metal microparticles may be formed. Preferably, the microparticles may be dispersed evenly throughout the binder composition. In some embodiments, the composite comprises metal nanoparticles and metal microparticles dispersed in a binder composition. Preferably, the nanoparticles and microparticles may be dispersed evenly throughout the binder composition. In some embodiments, the composite has select properties like that of the incorporated binder composition. In some embodiments, the composite has properties like that of a paste. In some embodiments, the composite may be capable of being spread over a surface by application of a force. Preferably, the viscosity of the composite may meet the needs of the intended application. In some embodiments, the viscosity of the composite may be tunable by selection and/or addition or removal of solvents and/or binder.

In some embodiments, the binder may be capable of being removed, via a heat treatment process, from the composite resulting in a substantially binder-free metal product. Preferably, the binder has a low oxygen content to prevent oxidation of the nanoparticles and/or microparticles.

Any of the embodiments of nanoparticles, nanopowders, microparticles, and microparticles described herein can be produced by plasma methods; that is, the nanoparticles, nanopowders, microparticles, and microparticles can be plasma-generated.

In some embodiments, a metal nanopowder, such as a silver nanopowder, is provided. The metal nanopowder can be combined with a binder. The metal nanopowder can be used to provide a paste.

In one embodiment, a metal nanopowder is provided where at least about 80% of the metal nanoparticles have an average particle size of between about 1 nm to 20 nm. In one embodiment, a metal nanopowder is provided where at least about 90% of the metal nanoparticles have an average particle size of between about 1 nm to 20 nm. In one embodiment, a metal nanopowder is provided where at least about 95% of the metal nanoparticles have an average particle size of between about 1 nm to 20 nm. In one embodiment, a metal nanopowder is provided where at least about 99% of the metal nanoparticles have an average particle size of between about 1 nm to 20 nm. Percentages are mole percent of particles (that is, stating that 80% of the particles have an average particle size of between about 1 nm to 20 nm indicates that for each 100 particles, 80 of the particles fall within the indicated size range).

In one embodiment, a metal nanopowder is provided where at least about 80% of the metal nanoparticles have an average particle size of between about 1 nm to 15 nm. In one embodiment, a metal nanopowder is provided where at least about 90% of the metal nanoparticles have an average particle size of between about 1 nm to 15 nm. In one embodiment, a metal nanopowder is provided where at least about 95% of the metal nanoparticles have an average particle size of between about 1 nm to 15 nm. In one embodiment, a metal nanopowder is provided where at least about 99% of the metal nanoparticles have an average particle size of between about 1 nm to 15 nm. Percentages are mole percent of particles.

In one embodiment, a metal nanopowder is provided where at least about 80% of the metal nanoparticles have an average particle size of between about 1 nm to 10 nm. In one embodiment, a metal nanopowder is provided where at least about 90% of the metal nanoparticles have an average particle size of between about 1 nm to 10 nm. In one embodiment, a metal nanopowder is provided where at least about 95% of the metal nanoparticles have an average particle size of between about 1 nm to 10 nm. In one embodiment, a metal nanopowder is provided where at least about 99% of the metal nanoparticles have an average particle size of between about 1 nm to 10 nm. Percentages are mole percent of particles.

In one embodiment, a metal nanopowder is provided where at least about 80% of the metal nanoparticles have an average particle size of between about 1 nm to 5 nm. In one embodiment, a metal nanopowder is provided where at least about 90% of the metal nanoparticles have an average particle size of between about 1 nm to 5 nm. In one embodiment, a metal nanopowder is provided where at least about 95% of the metal nanoparticles have an average particle size of between about 1 nm to 5 nm. In one embodiment, a metal nanopowder is provided where at least about 99% of the metal nanoparticles have an average particle size of between about 1 nm to 5 nm. Percentages are mole percent of particles.

In one embodiment, a metal nanopowder is provided where at least about 80% of the metal nanoparticles have a particle size of between about 1 nm to 15 nm. In one embodiment, a metal nanopowder is provided where at least about 90% of the metal nanoparticles have a particle size of between about 1 nm to 15 nm. In one embodiment, a metal nanopowder is provided where at least about 95% of the metal nanoparticles have a particle size of between about 1 nm to 15 nm. In one embodiment, a metal nanopowder is provided where at least about 99% of the metal nanoparticles have a particle size of between about 1 nm to 15 nm. Percentages are mole percent of particles (that is, stating that 80% of the particles have a particle size of between about 1 nm to 15 nm indicates that for each 100 particles, 80 of the particles fall within the indicated size range).

In one embodiment, a metal nanopowder is provided where at least about 80% of the metal nanoparticles have a particle size of between about 2 nm to 15 nm. In one embodiment, a metal nanopowder is provided where at least about 90% of the metal nanoparticles have a particle size of between about 2 nm to 15 nm. In one embodiment, a metal nanopowder is provided where at least about 95% of the metal nanoparticles have a particle size of between about 2 nm to 15 nm. In one embodiment, a metal nanopowder is provided where at least about 99% of the metal nanoparticles have a particle size of between about 2 nm to 15 nm. Percentages are mole percent of particles.

In one embodiment, a metal nanopowder is provided where at least about 80% of the metal nanoparticles have a particle size of between about 3 nm to 15 nm. In one embodiment, a metal nanopowder is provided where at least about 90% of the metal nanoparticles have a particle size of between about 3 nm to 15 nm. In one embodiment, a metal nanopowder is provided where at least about 95% of the metal nanoparticles have a particle size of between about 3 nm to 15 nm. In one embodiment, a metal nanopowder is provided where at least about 99% of the metal nanoparticles have a particle size of between about 3 nm to 15 nm. Percentages are mole percent of particles.

In one embodiment, a metal nanopowder is provided where at least about 80% of the metal nanoparticles have a particle size of between about 3 nm to 12 nm. In one embodiment, a metal nanopowder is provided where at least about 90% of the metal nanoparticles have a particle size of between about 3 nm to 12 nm. In one embodiment, a metal nanopowder is provided where at least about 95% of the metal nanoparticles have a particle size of between about 3 nm to 12 nm. In one embodiment, a metal nanopowder is provided where at least about 99% of the metal nanoparticles have a particle size of between about 3 nm to 12 nm. Percentages are mole percent of particles.

In one embodiment, a silver nanopowder is provided where at least about 80% of the silver nanoparticles have an average particle size of between about 1 nm to 20 nm. In one embodiment, a silver nanopowder is provided where at least about 90% of the silver nanoparticles have an average particle size of between about 1 nm to 20 nm. In one embodiment, a silver nanopowder is provided where at least about 95% of the silver nanoparticles have an average particle size of between about 1 nm to 20 nm. In one embodiment, a silver nanopowder is provided where at least about 99% of the silver nanoparticles have an average particle size of between about 1 nm to 20 nm. Percentages are mole percent of particles.

In one embodiment, a silver nanopowder is provided where at least about 80% of the silver nanoparticles have an average particle size of between about 1 nm to 15 nm. In one embodiment, a silver nanopowder is provided where at least about 90% of the silver nanoparticles have an average particle size of between about 1 nm to 15 nm. In one embodiment, a silver nanopowder is provided where at least about 95% of the silver nanoparticles have an average particle size of between about 1 nm to 15 nm. In one embodiment, a silver nanopowder is provided where at least about 99% of the silver nanoparticles have an average particle size of between about 1 nm to 15 nm. Percentages are mole percent of particles.

In one embodiment, a silver nanopowder is provided where at least about 80% of the silver nanoparticles have an average particle size of between about 1 nm to 10 nm. In one embodiment, a silver nanopowder is provided where at least about 90% of the silver nanoparticles have an average particle size of between about 1 nm to 10 nm. In one embodiment, a silver nanopowder is provided where at least about 95% of the silver nanoparticles have an average particle size of between about 1 nm to 10 nm. In one embodiment, a silver nanopowder is provided where at least about 99% of the silver nanoparticles have an average particle size of between about 1 nm to 10 nm. Percentages are mole percent of particles.

In one embodiment, a silver nanopowder is provided where at least about 80% of the silver nanoparticles have an average particle size of between about 1 nm to 5 nm. In one embodiment, a silver nanopowder is provided where at least about 90% of the silver nanoparticles have an average particle size of between about 1 nm to 5 nm. In one embodiment, a silver nanopowder is provided where at least about 95% of the silver nanoparticles have an average particle size of between about 1 nm to 5 nm. In one embodiment, a silver nanopowder is provided where at least about 99% of the silver nanoparticles have an average particle size of between about 1 nm to 5 nm. Percentages are mole percent of particles.

In one embodiment, a silver nanopowder is provided where at least about 80% of the silver nanoparticles have an average particle size of between about 4 nm to 11 nm. In one embodiment, a silver nanopowder is provided where at least about 90% of the silver nanoparticles have an average particle size of between about 4 nm to 11 nm. In one embodiment, a silver nanopowder is provided where at least about 95% of the silver nanoparticles have an average particle size of between about 4 nm to 11 nm. In one embodiment, a silver nanopowder is provided where at least about 99% of the silver nanoparticles have an average particle size of between about 4 nm to 11 nm. Percentages are mole percent of particles.

In one embodiment, a silver nanopowder is provided where at least about 80% of the silver nanoparticles have an average particle size of between about 6 nm to 9 nm. In one embodiment, a silver nanopowder is provided where at least about 90% of the silver nanoparticles have an average particle size of between about 6 nm to 9 nm. In one embodiment, a silver nanopowder is provided where at least about 95% of the silver nanoparticles have an average particle size of between about 6 nm to 9 nm. In one embodiment, a silver nanopowder is provided where at least about 99% of the silver nanoparticles have an average particle size of between about 6 nm to 9 nm. Percentages are mole percent of particles.

In one embodiment, a silver nanopowder is provided where at least about 80% of the silver nanoparticles have a particle size of between about 1 nm to 15 nm. In one embodiment, a silver nanopowder is provided where at least about 90% of the silver nanoparticles have a particle size of between about 1 nm to 15 nm. In one embodiment, a silver nanopowder is provided where at least about 95% of the silver nanoparticles have a particle size of between about 1 nm to 15 nm. In one embodiment, a silver nanopowder is provided where at least about 99% of the silver nanoparticles have a particle size of between about 1 nm to 15 nm. Percentages are mole percent of particles.

In one embodiment, a silver nanopowder is provided where at least about 80% of the silver nanoparticles have a particle size of between about 2 nm to 15 nm. In one embodiment, a silver nanopowder is provided where at least about 90% of the silver nanoparticles have a particle size of between about 2 nm to 15 nm. In one embodiment, a silver nanopowder is provided where at least about 95% of the silver nanoparticles have a particle size of between about 2 nm to 15 nm. In one embodiment, a silver nanopowder is provided where at least about 99% of the silver nanoparticles have a particle size of between about 2 nm to 15 nm. Percentages are mole percent of particles.

In one embodiment, a silver nanopowder is provided where at least about 80% of the silver nanoparticles have a particle size of between about 3 nm to 15 nm. In one embodiment, a silver nanopowder is provided where at least about 90% of the silver nanoparticles have a particle size of between about 3 nm to 15 nm. In one embodiment, a silver nanopowder is provided where at least about 95% of the silver nanoparticles have a particle size of between about 3 nm to 15 nm. In one embodiment, a silver nanopowder is provided where at least about 99% of the silver nanoparticles have a particle size of between about 3 nm to 15 nm. Percentages are mole percent of particles.

In one embodiment, a silver nanopowder is provided where at least about 80% of the silver nanoparticles have a particle size of between about 3 nm to 12 nm. In one embodiment, a silver nanopowder is provided where at least about 90% of the silver nanoparticles have a particle size of between about 3 nm to 12 nm. In one embodiment, a silver nanopowder is provided where at least about 95% of the silver nanoparticles have a particle size of between about 3 nm to 12 nm. In one embodiment, a silver nanopowder is provided where at least about 99% of the silver nanoparticles have a particle size of between about 3 nm to 12 nm. Percentages are mole percent of particles.

In one embodiment, a silver nanopowder is provided where at least about 80% of the silver nanoparticles have a particle size of between about 4 nm to 11 nm. In one embodiment, a silver nanopowder is provided where at least about 90% of the silver nanoparticles have a particle size of between about 4 nm to 11 nm. In one embodiment, a silver nanopowder is provided where at least about 95% of the silver nanoparticles have a particle size of between about 4 nm to 11 nm. In one embodiment, a silver nanopowder is provided where at least about 99% of the silver nanoparticles have a particle size of between about 4 nm to 11 nm. Percentages are mole percent of particles.

In one embodiment, a silver nanopowder is provided where at least about 80% of the silver nanoparticles have a particle size of between about 6 nm to 9 nm. In one embodiment, a silver nanopowder is provided where at least about 90% of the silver nanoparticles have a particle size of between about 6 nm to 9 nm. In one embodiment, a silver nanopowder is provided where at least about 95% of the silver nanoparticles have a particle size of between about 6 nm to 9 nm. In one embodiment, a silver nanopowder is provided where at least about 99% of the silver nanoparticles have a particle size of between about 6 nm to 9 nm. Percentages are mole percent of particles.

In one embodiment, a silver nanopowder is provided where the melting point of the silver nanoparticles is below about 300° C. In one embodiment, a silver nanopowder is provided where the melting point of the silver nanoparticles is below about 250° C. In one embodiment, a silver nanopowder is provided where the melting point of the silver nanoparticles is below about 200° C. In one embodiment, a silver nanopowder is provided where the melting point of the silver nanoparticles is below about 150° C.

In one embodiment, a silver nanopowder is provided where the melting point of the silver nanoparticles is between about 100° C. and about 400° C. In one embodiment, a silver nanopowder is provided where the melting point of the silver nanoparticles is between about 100° C. and about 300° C. In one embodiment, a silver nanopowder is provided where the melting point of the silver nanoparticles is between about 100° C. and about 250° C. In one embodiment, a silver nanopowder is provided where the melting point of the silver nanoparticles is between about 100° C. and about 200° C. In one embodiment, a silver nanopowder is provided where the melting point of the silver nanoparticles is between about 100° C. and about 150° C. In one embodiment, a silver nanopowder is provided where the melting point of the silver nanoparticles is between about 150° C. and about 300° C. In one embodiment, a silver nanopowder is provided where the melting point of the silver nanoparticles is between about 150° C. and about 250° C. In one embodiment, a silver nanopowder is provided where the melting point of the silver nanoparticles is between about 150° C. and about 200° C. In one embodiment, a silver nanopowder is provided where the melting point of the silver nanoparticles is between about 200° C. and about 300° C. In one embodiment, a silver nanopowder is provided where the melting point of the silver nanoparticles is between about 200° C. and about 250° C.

In one embodiment, a silver nanopowder is provided where the sinter temperature of the silver nanoparticles is below about 300° C. In one embodiment, a silver nanopowder is provided where the sinter temperature of the silver nanoparticles is below about 250° C. In one embodiment, a silver nanopowder is provided where the sinter temperature of the silver nanoparticles is below about 200° C. In one embodiment, a silver nanopowder is provided where the sinter temperature of the silver nanoparticles is below about 150° C.

In one embodiment, a silver nanopowder is provided where the sinter temperature of the silver nanoparticles is between about 100° C. and about 400° C. In one embodiment, a silver nanopowder is provided where the sinter temperature of the silver nanoparticles is between about 100° C. and about 300° C. In one embodiment, a silver nanopowder is provided where the sinter temperature of the silver nanoparticles is between about 100° C. and about 250° C. In one embodiment, a silver nanopowder is provided where the sinter temperature of the silver nanoparticles is between about 100° C. and about 200° C. In one embodiment, a silver nanopowder is provided where the sinter temperature of the silver nanoparticles is between about 100° C. and about 150° C. In one embodiment, a silver nanopowder is provided where the sinter temperature of the silver nanoparticles is between about 150° C. and about 300° C. In one embodiment, a silver nanopowder is provided where the sinter temperature of the silver nanoparticles is between about 150° C. and about 250° C. In one embodiment, a silver nanopowder is provided where the sinter temperature of the silver nanoparticles is between about 150° C. and about 200° C. In one embodiment, a silver nanopowder is provided where the sinter temperature of the silver nanoparticles is between about 200° C. and about 300° C. In one embodiment, a silver nanopowder is provided where the sinter temperature of the silver nanoparticles is between about 200° C. and about 250° C.

In one embodiment, a silver paste or silver-containing composition is provided. The silver paste or silver-containing composition can comprise any of the silver nanopowders or silver nanoparticles as described herein. In one embodiment, the silver paste or silver-containing composition comprises a solvent. In some embodiments, the solvent is selected from the group consisting of alpha-terpineol, propylene glycol methyl ether acetate (PGMEA), Texanol® (TEXANOL is a registered trademark of Eastman Chemical Company Corp., Kingsport, Tennesee, for 2,2,4-trimethyl-1,3-pentanediol mono(2-methylpropanoate), 3-hydroxy-2,2,4-trimethylpentyl isobutyrate, butylglycol, and/or methoxypropylacetate.

In one embodiment, a silver paste or silver-containing composition is provided. In some embodiments, a dispersant, such as DisperBYK®-145 (a phosphoric ester salt of a high molecular weight copolymer) from BYK (DisperBYK is a registered trademark of BYK-Chemie GmbH LLC, Wesel, Germany for chemicals for use as dispersing and wetting agents) is added to the silver paste or silver-containing composition.

In one embodiment, a silver paste or silver-containing composition is provided which comprises both a solvent as described above and a dispersant as described above. In one embodiment, the silver nanoparticles comprise from about 5% to about 10% by weight of the solids in the composition. In one embodiment, the silver nanoparticles comprise from about 6% to about 9% by weight of the solids in the composition. In one embodiment, the silver nanoparticles comprise from about 6% to about 8% by weight of the solids in the composition. In one embodiment, the silver nanoparticles comprise about 7% by weight of the solids in the composition.

In any of the embodiments of the silver paste or silver-containing composition, the dispersant and solvent decompose, carbonize, boil off, or outgas at a temperature below the sinter temperature of the silver nanoparticles. In further embodiments, the dispersant and solvent decompose, carbonize, boil off, or outgas at a temperature about 25° C. below, about 50° C. below, about 75° C. below, or about 100° C. below the sinter temperature of the silver nanoparticles. In further embodiments, the dispersant and solvent decompose, carbonize, boil off, or outgas at a temperature between about 25° C. to 50° C. below, between about 25° C. to 75° C. below, about 25° C. to 100° C. below, or about 50° C. to 100° C. below the sinter temperature of the silver nanoparticles.

In one embodiment, the invention provides a method of making silver nanoparticles, comprising: a) introducing silver (such as in solid or liquid form) into a plasma stream to form silver vapor; and b) rapidly condensing the silver vapor to form solid silver metal nanoparticles, such as silver nanoparticles where at least about 80 mole % of the silver nanoparticles have a particle size of between about 1 nm to 15 nm. In one embodiment, the rapid condensation is effected by injecting argon quench gas into the vapor at a rate of at least 2000 liters per minute. In one embodiment, the plasma stream comprises argon that has been passed through a plasma torch.

In any of the embodiments above, after condensing the silver vapor to form solid silver metal nanoparticles, the solid silver metal nanoparticles can be directed into an expanded region for additional cooling and collection. The expanded region can be a baghouse, such as a shaker baghouse, a reverse air baghouse, or a pulse jet baghouse.

In another embodiment, the invention provides a method of making silver paste or silver-containing composition, comprising mixing the silver nanoparticles of any one of the embodiments as disclosed herein with a dispersant and a solvent to form a nanoparticle/dispersant/solvent mixture; sonicating the nanoparticle/dispersant/solvent mixture; centrifuging the nanoparticle/dispersant/solvent mixture; and drying the supernatant of the centrifuged nanoparticle/dispersant/solvent mixture to form silver paste. After centrifuging the nanoparticle/dispersant/solvent mixture, the size distribution of the supernatant of the nanoparticle/dispersant/solvent mixture can be measured. The size distribution can be measured by dynamic light scattering or ultracentrifugation.

The present disclosure provides compositions that may be useful in creating electrical circuitry. Composites comprising nanoparticles and/or microparticles may have a tunable sintering or melting temperature and may be used to produce electrical circuitry with low resistivity. Furthermore, use of composites comprising nanoparticles and/or microparticles may allow for the production of circuitry with densely placed conductive wires or traces through which electrical current can flow. It is a notable observation of the present disclosure that composites containing smaller metal particles may bind more tightly to a substrate or surface and therefore the composite can be used to produce, for example, electrical circuitry on a broad range of substrates.

### BRIEF DESCRIPTION OF THE DRAWINGS

The invention is better understood by reading the following detailed description of an exemplary embodiment in conjunction with the accompanying drawings.

FIG. 1 illustrates a graph showing particle size distribution of plasma-generated metal particles.

FIG. 2 illustrates a graph showing an exemplary relationship of the melting and sintering temperatures of a composite material comprising nanoparticles and/or microparticles.

FIG. 3A illustrates a mixture of nanoparticles, microparticles, and a binder.

FIG. 3B illustrates a composite of nanoparticles and microparticles after being heated.

FIG. 4 illustrates the process steps in forming a composite with tunable melting and sintering temperatures.

### DETAILED DESCRIPTION OF THE INVENTION

In the following description, numerous details and alternatives are set forth for purpose of explanation. However, one of ordinary skill in the art will realize that the invention can be practiced without the use of these specific details.

When numerical values are expressed herein using the term “about” or the term “approximately,” it is understood that both the value specified, as well as values reasonably close to the value specified, are included. For example, the description “about 1 nm” or “approximately 1 nm” includes both the disclosure of 1 nm itself, as well as values close to 1 nm. Thus, the phrases “about X” or “approximately X” include a description of the value X itself. If a range is indicated, such as “approximately 1 nm to 10 nm,” it is understood that both the values specified by the endpoints are included, and that values close to each endpoint or both endpoints are included for each endpoint or both endpoints; that is, “approximately 1 nm to 10 nm” is equivalent to reciting both “1 nm to 10 nm” and “approximately 1 nm to approximately 10 nm.” Where necessary, the word “about” and/or the word “approximately” may be omitted from the definition of the invention.

The word “substantially” does not exclude “completely.” E.g., a composition which is “substantially free” from Y may be completely free from Y. The term “substantially free” permits trace or naturally occurring impurities. It should be noted that, during fabrication, handling, or processing of a composition of matter, small amounts of trace materials may be incorporated into the composition of matter. Accordingly, use of the terms “substantial absence of” and “substantially free of” is not to be construed as absolutely excluding minor amounts of the materials referenced. Where necessary, the word “substantially” may be omitted from the definition of the invention.

It is an object of the disclosure to provide for a cost-efficient composition comprising metal that: (a) may have a desired sintering or melting temperature that is compatible with electronic fabrications and semiconductor processing steps; (b) may be highly conductive; (c) may be formed with a resulting low level of metal oxidation; and (d) may be produced in bulk quantities. In one embodiment, the conductivity of the metal resulting from fabrication with the composites of the invention is at least about 1 percent, at least about 5 percent, at least about 10 percent, at least about 15 percent, at least about 20 percent, at least about 30 percent, at least about 40 percent, at least about 50 percent, at least about 60 percent, at least about 70 percent, at least about 75 percent, at least about 80 percent, at least about 90 percent, at least about 95 percent, at least about 98 percent, at least about 99 percent, at least about 99.5 percent, or at least about 99.9 percent of the conductivity of the bulk metal or bulk alloy used in the nanoparticles and/or microparticles of the composites; in a further embodiment, the metal used in the nanoparticles and/or microparticles of the composites is silver. In one embodiment, the level of metal oxidation during fabrication is less than about 30 mole percent, less than about 25 mole percent, less than about 20 mole percent, less than about 15 mole percent, less than about 10 mole percent, less than about 5 mole percent, less than about 2 mole percent, less than about 1 mole percent, less than about 0.5 mole percent, less than about 0.2 mole percent, less than about 0.1 mole percent, less than about 0.05 mole percent, less than about 0.02 mole percent, or less than about 0.01 mole percent of the metal in the nanoparticles and/or microparticles; in a further embodiment, the metal used in the nanoparticles and/or microparticles of the composites is silver. In one embodiment, the electronic fabrication or semiconductor processing step or steps are performed under an inert atmosphere (such as nitrogen or argon) or under vacuum, in order to exclude oxygen.

This disclosure refers to composite compositions comprising nanometer-sized “particles” and “powders.” These two terms are equivalent, except for the single caveat that a singular “powder” refers to a collection of particles. The present invention may apply to a wide variety of powders and particles. Powders that fall within the scope of the present invention may include, but are not limited to, any of the following: (a) nanostructured particles and powders (nanoparticles and nanopowders, respectively), having an average particle size less than about 100 nanometers and an aspect ratio between one and one million; (b) submicron powders, having an average particle size greater than about 100 nanometers and less than about 1 micron and an aspect ratio between one and one million; and, (c) ultra-fine powders, having an average particle size of greater than about 1 micron and less than about 100 microns and an aspect ratio between one and one million.

The particles discussed in the disclosure may be produced by a variety of methods well known in the art. Preferably, the nanoparticles are generated by plasma-based techniques. Reference is made to U.S. Patent Application Publication No. 2008/0277267, U.S. Pat. No. 8,663,571, U.S. patent application Ser. No. 14/207,087 and International Patent Appl. No. PCT/US2014/024933, the contents of which are incorporated by reference herein in their entirety, for complete description of methods of preparing particles by plasma-based techniques applicable in the hereinafter described invention. Additional methods for generation of plasma are those disclosed in U.S. Pat. No. 5,989,648, U.S. Pat. No. 6,689,192, U.S. Pat. No. 6,755,886, and US 2005/0233380. Plasma guns such as those disclosed in US 2011/0143041 can be used.

In some embodiments, the nanoparticles produced by plasma-based techniques may be collected under inert conditions resulting in a minimal oxide layer on said produced nanoparticles. In some embodiments, silver nanoparticles produced by plasma-based techniques may be collected under inert conditions resulting in the formation of silver nanoparticles with minimal levels of oxide formation within or on the silver nanoparticle.

For the production of silver nanoparticles by plasma-based methods, it is particularly important to rapidly cool the silver nanoparticles after formation. Silver nanoparticles have a relatively low sintering temperature, and collisions between hot or warm nanoparticles during plasma synthesis will result in larger particles and a relatively broader size distribution unless very rapid quench and cooling methods are used, as described in United States Patent Appl. Publication No. 2008/0277267, U.S. Pat. No. 8,663,571, United States Patent Appl. Publication No. US 2014/0263190, and International Patent Appl. No. WO 2014/159736. In one embodiment, the plasma synthesis apparatus used can be modified so that, after initial condensation of silver vapor into particles, instead of funneling the newly-formed particles into a narrower region for cooling and collection, the newly-formed particles travel into an expanded region for cooling (that is, cooling to room temperature) and collection. In one embodiment, the expanded region can be a baghouse. The baghouse can be a shaker baghouse, a reverse air baghouse, or a pulse jet baghouse. Directing the newly-formed particles into an expanded region for cooling and collection reduces collisions and subsequent undesirable sintering between the warm particles.

“Particle size” can be measured using a variety of methods, such as electron microscopy and dynamic light scattering. When calculating a diameter of a particle, the average of its longest and shortest dimension is taken; thus, the diameter of an ovoid particle with long axis 20 nm and short axis 10 nm would be 15 nm. The average diameter of a population of particles is the average of diameters of the individual particles, and can be measured by various techniques known to those of skill in the art. “Grain size” can be measured using a variety of methods, such as the ASTM (American Society for Testing and Materials) standard (see ASTM E112-10).

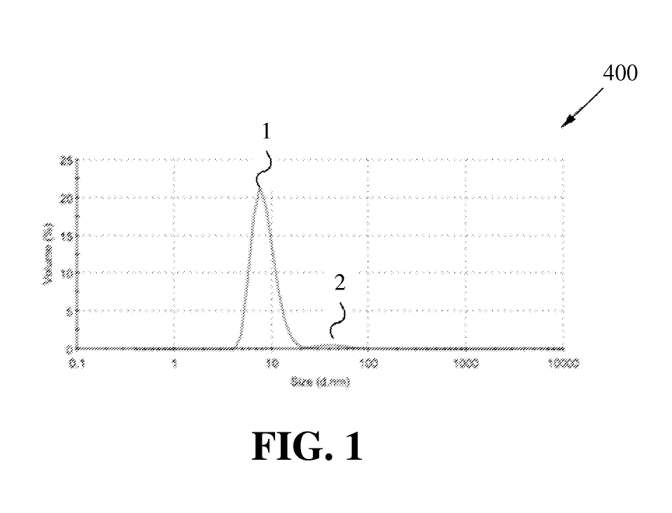

As used herein, “nanopowder” refers to particles of metal having an average particle size of less than about 100 nanometers and an aspect ratio between one and one million. In some embodiments, a nanopowder may have an average particle size of less than 75 nm. In some embodiments, a nanopowder may have an average particle size of less than 50 nm. In some embodiments, a nanopowder has an average particle size of less than 25 nm. In some embodiments, a nanopowder may have an average particle size of less than 10 nm. The average particle size of a nanopowder may be calculated from the distribution of differently sized nanoparticles in said nanopowder. As illustrated in FIG. 1, a nanopowder with an average particle size of 8.6 nm 1 is composed of a distribution of differently sized nanoparticles. In some embodiments, the nanopowder may contain additional, less abundant, distributions of nanoparticles 2.

In some embodiments where the nanopowder may contain additional, less abundant, distributions of nanoparticles 2, 1% (by volume) of the nanopowder may be composed of nanoparticles with particle sizes that fall within an additional distribution and/or distributions of particles. In some embodiments, 2% (by volume) of the nanopowder may be composed of nanoparticles with particle sizes that fall within an additional distribution and/or distributions of particles. In some embodiments, 3% (by volume) of the nanopowder may be composed of nanoparticles with particle sizes that fall within an additional distribution and/or distributions of particles. In some embodiments, 4% (by volume) of the nanopowder may be composed of nanoparticles with particle sizes that fall within an additional distribution and/or distributions of particles. In some embodiments, 5% (by volume) of the nanopowder may be composed of nanoparticles with particle sizes that fall within an additional distribution and/or distributions of particles. In some embodiments, 10% (by volume) of the nanopowder may be composed of nanoparticles with particle sizes that fall within an additional distribution and/or distributions of particles. In some embodiments, 15% (by volume) of the nanopowder may be composed of nanoparticles with particle sizes that fall within an additional distribution and/or distributions of particles.

In some embodiments, a dispersion of nanoparticles may be created. Generally, the nanoparticles may be dispersed in an organic solvent. In some embodiments, nanoparticles may be dispersed in alpha-terpineol, propylene glycol methyl ether acetate (PGMEA), Texanol® (TEXANOL is a registered trademark of Eastman Chemical Company Corp., Kingsport, Tenn., for 2,2,4-trimethyl-1,3-pentanediol mono(2-methylpropanoate), 3-hydroxy-2,2,4-trimethylpentyl isobutyrate, butylglycol, and/or methoxypropylacetate.

In some embodiments, a dispersant, such as DisperBYK®-145 (a phosphoric ester salt of a high molecular weight copolymer) from BYK (DisperBYK is a registered trademark of BYK-Chemie GmbH LLC, Wesel, Germany for chemicals for use as dispersing and wetting agents) is added to the dispersion of the nanoparticles.

In some embodiments, nanoparticle dispersions may have at least 60% metal content. In some embodiments, nanoparticle dispersions may have at least 50% metal content. In some embodiments, nanoparticle dispersions may have at least 40% metal content. In some embodiments, nanoparticle dispersions may have at least 30% metal content. In some embodiments, nanoparticle dispersions may have at least 20% metal content. In some embodiments, nanoparticle dispersions may have at least 10% metal content. In some embodiments, nanoparticle dispersions may have at least 5% metal content. In some embodiments, nanoparticle dispersions may have between at least 5% to 60% metal content, at least 5% to 50% metal content, at least 5% to 40% metal content, at least 5% to 30% metal content, at least 5% to 25% metal content, at least 5% to 20% metal content, at least 5% to 10% metal content, at least 6% to 9% metal content, at least 6% to 8% metal content, or at least 7% metal content. In some embodiments, metal content is measured as a percentage of total solids.

For purposes of this description, “microparticle” refers to a particle of metal having an average particle size of greater than about 100 nanometers and less than 100 micron and an aspect ratio between one and one million. Both submicron powders and ultra-fine powders may be composed of microparticles.

In some embodiments, a micropowder may have an average particle size of less than 50 microns. In some embodiments, a micropowder may have an average particle size of less than 25 microns. In some embodiments, a micropowder may have an average particle size of less than 10 microns. In some embodiments, a micropowder may have an average particle size of less than 5 microns. In some embodiments, a micropowder may have an average particle size of less than 1 microns (and can be referred to as a “sub-micropowder”). In some embodiments, a micropowder may have an average particle size of less than 0.5 microns (and can be referred to as a “sub-micropowder”). The average particle size of a micropowder may be calculated from the distribution of differently sized microparticles in said micropowder. In some embodiments, the micropowder may contain additional, less abundant, distributions of microparticles. In some embodiments, 1% (by volume) of the micropowder may be composed of microparticles with particle sizes that fall within an additional distribution and/or distributions of particles. In some embodiments, 2% (by volume) of the micropowder may be composed of microparticles with particle sizes that fall within an additional distribution and/or distributions of particles. In some embodiments, 3% (by volume) of the micropowder may be composed of microparticles with particle sizes that fall within an additional distribution and/or distributions of particles. In some embodiments, 4% (by volume) of the micropowder may be composed of microparticles with particle sizes that fall within an additional distribution and/or distributions of particles. In some embodiments, 5% (by volume) of the micropowder may be composed of microparticles with particle sizes that fall within an additional distribution and/or distributions of particles. In some embodiments, 10% (by volume) of the micropowder may be composed of microparticles with particle sizes that fall within an additional distribution and/or distributions of particles. In some embodiments, 15% (by volume) of the micropowder may be composed of microparticles with particle sizes that fall within an additional distribution and/or distributions of particles.

As used herein, a “composite composition” or “composite” refers to a substance comprising metal particles dispersed in a binder composition. In some embodiments, a composite comprising metal nanoparticles may be formed. Preferably, the nanoparticles may be dispersed evenly throughout the binder composition. In some embodiments, a composite comprising metal microparticles may be formed. Preferably, the microparticles may be dispersed evenly throughout the binder composition. In some embodiments, the composite comprises metal nanoparticles and metal microparticles dispersed in a binder composition. Preferably, the nanoparticles and microparticles may be dispersed evenly throughout the binder composition. In some embodiments, the composite may have select properties like that of the incorporated binder composition. In some embodiments, the composite may have properties like that of a paste. In some embodiments, the composite may be capable of being spread over a surface by application of a force. In some embodiments, the composite may be capable of being used in a silkscreen printing process. In some embodiments, the composite may be capable of being used as a printable ink. In some embodiments, the composite may be used in variety of printing methods, such as gravure, flexo, rotary, dispenser, and offset printing. Preferably, the viscosity of the composite may meet the needs of the intended application. In some embodiments, the viscosity of the composite may be selected from a range of about 1-200,000 centipoise (cP). In some embodiments, the viscosity of the composite is about 1-100,000 cP. In some embodiments, the viscosity of the composite is about 1-10,000 cP. In some embodiments, the viscosity of the composite is about 1-1,000 cP. In some embodiments, the viscosity of the composite is about 1-100 cP. In some embodiments, the viscosity of the composite is about 1-50 cP. In some embodiments, the viscosity of the composite is about 1-25 cP. In some embodiments, the viscosity of the composite is about 1-15 cP. In some embodiments, the viscosity of the composite is about 1-10 cP. In some embodiments, the viscosity of the composite is about 1-5 cP. In some embodiments, the viscosity of the composite is about 2.5-3.5 cP. In some embodiments, the viscosity of the composite is tunable by selection and/or addition or removal of solvents and/or binder.

As used herein, “binder” refers to a composition that may be used to stabilize a dispersion of metal nanoparticles and/or microparticles. In some embodiments, the binder may be capable of holding a desired shape for a period of time. In a further embodiment, the binder may be capable of holding a desired shape during a heat treatment process. In some embodiments, the binder may be capable of being spread over a surface by application of a force. In some embodiments, the binder may be capable of being used in a silkscreen printing process. In some embodiments, the binder may be capable of being used as a printable ink. In some embodiments, the binder may be capable of being removed, via a heat treatment process, from the composite resulting in a substantially binder-free, metal product. In some embodiments the binder may be capable of decomposing, carbonizing, boiling-off, and/or outgassing at a desired temperature. Preferably, the binder may have a low oxygen content to prevent oxidation of the nanoparticles or microparticles. In some embodiments, the oxygen content of the binder is less than about 30 mole percent, less than about 25 mole percent, less than about 20 mole percent, less than about 15 mole percent, less than about 10 mole percent, less than about 5 mole percent, less than about 2 mole percent, less than about 1 mole percent, less than about 0.5 mole percent, less than about 0.2 mole percent, less than about 0.1 mole percent, less than about 0.05 mole percent, less than about 0.02 mole percent, or less than about 0.01 mole percent, where mole percent is measured as [(moles of binder) divided by (moles of metal) multiplied by 100]. In some embodiments, the binder may be a polymeric natural or synthetic compound. In some embodiments, the binder may be a resin. In some embodiments, the binder may be an epoxy resin. In some embodiments, the binder may be an acrylic resin. In one embodiment, the binder is PGMEA.

The binder and metal particles may comprise a resulting composite. In some embodiments, the resulting composite may have a metal content of at least about 90%. In some embodiments, the resulting composite may have a metal content of at least about 80%. In some embodiments, the resulting composite may have a metal content of at least about 70%. In some embodiments, the resulting composite may have a metal content of at least about 60%. In some embodiments, the resulting composite may have a metal content of at least about 50%. In some embodiments, the resulting composite may have a metal content of at least about 40%. Percentages are given by weight.

As used herein, “metal” refers to single element metals and metal alloys. The metal or alloy can include, but is not limited to, silver, copper, gold, nickel, or cobalt. Preferably, the metal is used commercially as an electrical conductor. In some embodiments, the metal particles are at least 99.999% pure metal. In some embodiments, the metal particles are at least 99.99% pure metal. In some embodiments, the metal particles are at least 99.9% pure metal. In some embodiments, the metal particles are at least 99.0% pure metal. In some embodiments, the metal particles are at least 95.0% pure metal. In some embodiments, where silver is used, the silver particles are 99.999% pure (five-nines fine) silver. In some embodiments, where silver is used, the silver particles are 99.99% pure (four-nines fine) silver. In some embodiments, the silver particles are 99.9% pure (three-nines fine) silver. In some embodiments, the silver particles are 99.0% pure (two-nines fine) silver. In some embodiments, the nanoparticles or microparticles comprise a silver alloy. Purity measurement is made on the isolated metal particles, and does not include additives such as solvents or binders in a particle-containing composition. Purity measurements on alloys refer to each individual component used in the alloy; for example, a silver-copper alloy that is at least 99% pure contains silver which is at least 99% pure and copper which is at least 99% pure. Percentage purity refers to mole percent of the chemical substances present in the composition.

The metal contained within the composite of the present application may have a tunable bonding temperature. As used herein, “tunable” refers to the capability to control, and/or achieve a desired characteristic. As used herein, “bonding temperature” refers to the approximate temperature at which a metal particle or surface of a metal or metal alloy within a composite may bond to another particle or another surface of a metal or metal alloy. In some embodiments, the bonding temperature may be the approximate temperature at which metal within a composite may be melted together. In some embodiments, the bonding temperature may be the approximate temperature at which metal within a composite may be sintered together. As used herein, “melting temperature” refers to the approximate temperature at which a metal or metal alloy may undergo a phase transition from a solid metal to a liquid metal. In some embodiments, when the liquid metal is cooled and returns to solid metal, a plurality of metal particles may form a single joined metal structure. As used herein, “sinter temperature” refers to the approximate temperature at which a metal or metal alloy may be able to form a solid mass with other components without melting the entire metal particle to the point of liquefaction. In some embodiments, a plurality of metal particles may be sintered together to form a single joined metal structure.

As used in this disclosure, “sintering” is defined as the temperature-induced coalescence and densification of solid particles below the melting point of the solid, or, for a heterogeneous solid, below the melting points of the major components of the solid.

As used in this disclosure, bonding, melting, and sintering temperatures can refer to both the property of the composite as whole as well as the property of a single metal particle. In some embodiments, the composite may be sintered. Further, this sintering of the composite does not imply that all metal particles of said composite may undergo sintering. Likewise, sintering of the composite does not imply that no metal particles may undergo melting.

The composite has various characteristics which can be adjusted as needed by the particular application. These characteristics can be selected from any one of the following, or any combination of one or more of the following: a) a bonding temperature; b) a melting temperature; c) a sintering temperature; d) a print resolution; e) electrical conductivity; and f) a surface adherence capability.

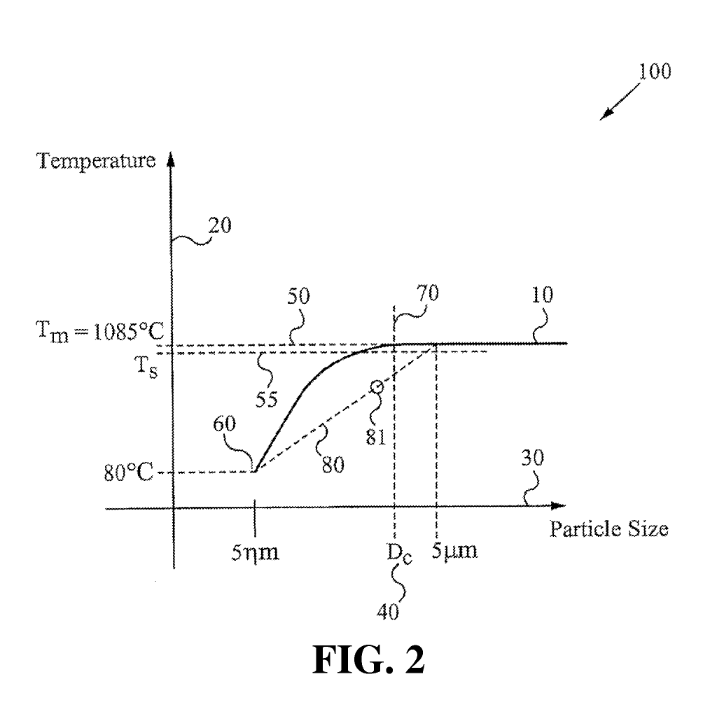

FIG. 2 illustrates the relationship between the particle size of a metal and the sintering and melting temperature of metal. For illustrative purposes only, the graph 100 is for copper particles. The curve 10 shows the melting temperature of copper as a function of particle size. A curve for the sintering temperature of copper may follow a curve below the melting point curve 10. The horizontal axis 30 represents the size of a copper particle. The vertical axis 20 illustrates the temperature in degrees centigrade. The melting point curve 10 of the copper particles illustrates the relationship between the copper particle size and the melting temperature of said copper particle. The graph illustrates a critical particle size (D_{c}) 40, at which for increasingly larger particles, the melting temperature does not increase above the melting temperature, Tₘ, 50 of bulk copper. The bulk melting temperature of copper is approximately 1085 degrees centigrade. The temperature at which the copper sinters, Tₛ, 55 of bulk copper is shown as a temperature below, but close to, the melting temperature of copper. Below the particle size D_{c}, the melting temperature decreases non-linearly. For 5 nanometer copper particles the melting point 60 drops to approximately 80 degrees centigrade.

The line 80 represents the melting point curve for an exemplary composite (e.g. a mixture of 5 nanometer copper particles and 5 micron copper particles). The higher the ratio of copper nanoparticles to copper microparticles in the composite composition, the lower the melting point of said composite may be. Thus, by selecting a specific ratio of nanoparticles and 5 micron particles, the melting or sintering temperature 81 for the composite composition may be tuned to meet a desired need. In order to reduce the melting or sintering temperature of the composite, the ratio of nanoparticles to microparticles in the composite may be increased. The slope of the line 80 may be changed by changing the size of the nanoparticles and/or microparticles. For illustrative purposes, in some embodiments, if larger nanoparticles are used while maintaining the size of the microparticles, the slope of the line 80 may flatten out. In alternate embodiments, if smaller microparticles are used while maintaining the size of the nanoparticle, the slope of the line 80 may become steeper. For illustrative purposes, line 80 is shown as being linear, but the position along the line does not necessarily represent a specific ratio of nanoparticles to microparticles.

In some embodiments, the composite comprises nanopowder. As previously discussed, additional particle size distributions of nanoparticles may be contained within said nanopowder. In such embodiments, the average particle size of the most abundant particle size metal nanoparticle distribution may be used to describe the particle size of the nanopowder. Wherein the composite composition comprises nanopowder, the melting or sintering temperature 81 of the composite composition may be tunable by adjusting the particle size of the nanopowder. To decrease the melting or sinter temperature of the composite composition 81, a smaller particle size may be used. To increase the melting or sinter temperature of the composite composition 81, a larger particle size may be used.

In some embodiments, the composite may comprise nanoparticles and/or microparticles. In some embodiments, at least about 70-100% of the metal content of the composite comprises nanoparticles, while the remainder of the composite comprises microparticles. In some embodiments, at least about 30-70% of the metal content of the composite comprises nanoparticles, while the remainder of the composite comprises microparticles. In some embodiments, at least about 0.5-30% of the metal content of the composite comprises nanoparticles, while the remainder of the composite comprises microparticles.

In some embodiments, the composite comprises a micropowder. As previously discussed, additional particle size distributions of microparticles may be contained within said micropowder. In such embodiments, the average particle size of the most abundant metal microparticle distribution may be used to describe the particle size of the micropowder. In order for a composite comprising micropowder to be tunable, the metal micropowder must exhibit a relationship of decreasing melting or sintering temperature of the metal microparticle with decreasing particle size below that of the critical particle size 40. By limitations of the established particle size definitions within this disclosure, this observed relationship must be seen for the metal microparticle above about 100 nm (i.e. the upper bound of what is defined as a nanoparticle). For example, it may be possible for a metal particle to have a characteristic critical particle size less than 100 nm. In this example, the metal microparticles would have the same sintering and melting temperature as bulk metal from which the particle is derived. Alternatively, the critical particle size for a metal may be greater than 100 nanometers. In this embodiment, a composite comprising micropowder derived from said metal may be tunable. Wherein the composite comprises micropowder, the melting or sintering temperature 81 of the composite composition may be tunable by adjusting the particle size of the micropowder. To decrease the melting or sinter temperature of the composite composition 81, a smaller particle size may be used. To increase the melting or sinter temperature of the composite composition 81, a larger particle size may be used.

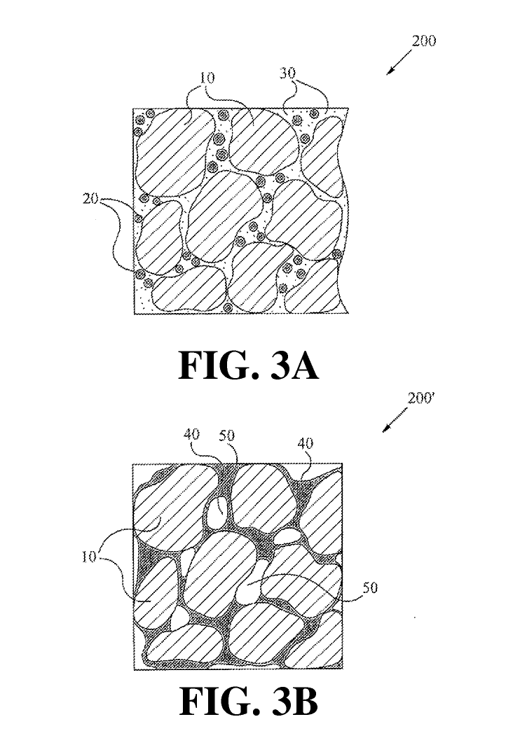

FIG. 3A is exemplar of a composite 200 of nanoparticles 20, microparticles 10, and binder 30 in a ratio for a selected bonding temperature. In this exemplar embodiment, the nanoparticles 20 and microparticles 10 are silver, but other metals, alloys, or materials are contemplated and the combination of metals, alloys, or other materials are contemplated. For this example, the bonding temperature may be either the selected melting temperature or sintering temperature of the composite. Here, the illustrated average particle size of the microparticles 10 may be from 0.1-100 microns in size. The illustrated average particle size of the nanoparticles 20 may be less than 10 nanometers in size. A binder may be selected to provide a mixture with specific properties. For one application, the binder 30 may be chosen so the composite may be capable of being spread, such as a paste can be, and may be applied to a silkscreen. For another application, the binder 30 may be selected so that the so that the composite is capable of forming a printable ink. Preferably, the composite 200 can hold a shape until a bonding temperature is applied to the composite composition. Preferably, the shape that the composite holds may be the same shape in which it was placed, or intended to be placed, on the substrate or surface. Further, the binder 30 may be selected to decompose, carbonizes, boil off, or outgas at a temperature below the bonding temperature. Preferably, when the binder 30 decomposes, carbonizes, boils off, or outgases, large voids are not left in the melted or sintered metal structure and the resulting bonded metal structure forms a low electrical resistance material. Preferably, the binder 30 may have a low oxygen content to prevent oxidation of the nanoparticles 20 or microparticles 30.

FIG. 3B is exemplar of the composite 200 after a bonding temperature has been applied and the composite has formed a resulting silver metal structure 200′. The metal structure may be composed of silver microparticles 10 connected by sintered silver material 40, substantially originating from silver nanoparticles 20. If the binder (FIG. 3A, 30) is not completely out-gassed or does not completely decompose, voids 50 in the sintered metal structure can be formed. In some embodiments, the sintered metal structure 200′ may be composed of conductive material containing voids 50 that may increase the resistivity of said metal structure. Preferably, substantially all of the binder is removed, and few, if any, voids remain or are formed in the metal structure 200′. Formation of a melted or sintered metal structure with few, if any, voids can result in a composite structure that may be highly conductive. A highly conductive structure may have a conductivity that is no less than 50% of the theoretical conductivity of the material used for the production of the silver nanoparticles and/or microparticles. For compositions such as nanoparticles and microparticles of silver and a binder, the binder should decompose below but near the sinter temperature of the composite.

As depicted in FIG. 3B, based on the temperature the metal particles reach during heat treatment, metal particles may experience different degrees of sintering and/or melting. In some embodiments, the heat treatment may raise the temperature of the metal contained in the composite to a temperature that may only cause a percentage of the total population of particles, those below an approximate particle size, to sinter and/or melt. For example, as illustrated in FIG. 3B, the heat treatment raised the temperature of the metal in the composite to a level where the nanoparticles in the composite sinter 40 and form bonds between other nanoparticles and microparticles. In this embodiment, the temperature resulting from the heat treatment does not elevate the temperature of the metal in the composite composition to a level that may result in sintering and/or melting of the microparticles 10. The resulting metal structure allows for conductivity of an electrical current with low resistivity. Preferably, the composite reached an elevated temperature wherein the binder may be completely removed from the composite.

The present disclosure provides compositions that may be useful in creating electrical circuitry. Composites comprising nanoparticles and/or microparticles may have a tunable sintering or melting temperature and may be used to produce electrical circuitry with low resistivity. Furthermore, use of composites comprising nanoparticles and/or microparticles may allow for the production of circuitry with densely placed conductive wires or traces through which electrical current can flow. It is a notable observation of the present disclosure that composites containing smaller metal particles may be used to print higher resolution wires or traces. The ability to print finer wires or traces allows for circuitry to be printed onto a substrate or a surface more closely together, thus the resulting ability to print circuitry in a denser manner than may be done with composites comprising larger metal particle sizes. In addition, it is noted that the present disclosure provides compositions that are capable of being used to produce wires and traces that exhibit minimal flow-out once applied to a substrate, both prior to and during heat treatment. The present disclosure provides compositions that are capable of being laser-sintered.

Furthermore, it is a notable observation of the present disclosure that composites containing smaller metal particles may bind more tightly to a substrate or surface after sintering. Without being bound to the following theory, it is thought that the smaller nanoparticles of a composite composition may better penetrate the porous micro-structure of a surface or substrate, such as Kapton tape. Therefore, when the composite is treated with heat to bond the metal particles via sintering, the resulting metal structure may have more thoroughly permeated the porous micro-structure of the substrate or surface, thus forming a stronger bond with the substrate or surface. This characteristic allows for the use of such compositions on a broader range of substrates. In some embodiments, the substrate may be Kapton tape, glass, polyester (PET) film, photovoltaic (PV) film, and/or copper indium gallium selenide (CIGS) film.

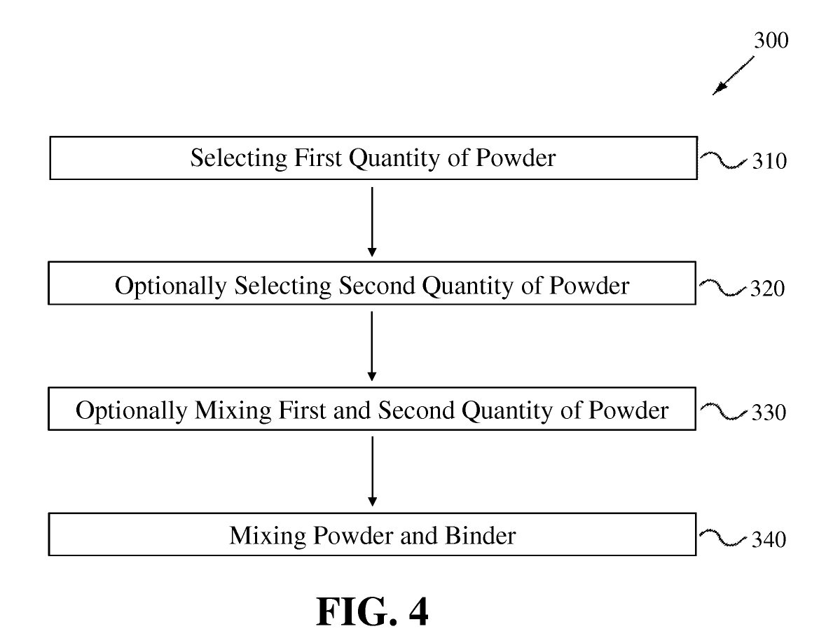

The present disclosure provides methods for the production of composites comprising nanoparticles and/or microparticles. FIG. 4 is a flowchart illustrating exemplary methods 300 for forming a composite comprising metal particles. In some embodiments, the method may be used to produce a composite comprising nanoparticles. In some embodiments the method may be used to produce a composite comprising microparticles. In some embodiments, the method may be used to produce a composite comprising nanoparticles and microparticles. As discussed in the present disclosure, said composite comprising nanoparticles and microparticles may have tunable sintering and melting temperatures. Furthermore, the composite produced from the method illustrated in FIG. 4 may be used to create a cost-efficient composite comprising metal that: (a) may have a desired sintering or melting temperature that is compatible with electronic fabrications and semiconductor processing steps; (b) may be highly conductive; (c) may be formed with a resulting low level of metal oxidation; and (d) may be produced in bulk quantities.

As would be appreciated by those of ordinary skill in the art, the protocols, processes, and procedures described herein may be repeated continuously or as often as necessary to satisfy the needs described herein. Additionally, although the steps of method 300 are shown in a specific order, certain steps may occur simultaneously or in a different order than is illustrated. Accordingly, the method steps of the present invention should not be limited to any particular order unless either explicitly or implicitly stated in the claims.

In some embodiments, the method may be used to produce a composite comprising nanoparticles. Following the steps of FIG. 4, the process begins at step 310. A first quantity of nanopowder of an approximate particle size may be selected based on the desired sintering or melting temperature of the resulting composite. Said quantity of nanoparticles may be produced by plasma-based techniques. In some embodiments, the nanopowder of an approximate particle size may be selected based on a desired characteristic of the resulting composite, such as the feasible print resolution of the resulting composite. It is presumed that the quantity of nanopowder used in a single step is composed of nanoparticles comprising a distribution of particle sizes that are substantially mixed together. In these embodiments which produce a composite comprising nanoparticles, optional steps 320 and 330 in FIG. 4 are skipped. In step 340, the quantity of nanopowder may be mixed with a binder to form a desired composite.

In some embodiments, the method may be used to produce a composite comprising microparticles. Following the steps of FIG. 4, the process begins at step 310. A first quantity of micropowder of an approximate particle size may be selected based on the desired sintering or melting temperature of the resulting composite. Said quantity of microparticles may be produced by plasma-based techniques. In some embodiments, the micropowder of an approximate particle size may be selected based on a desired characteristic of the resulting composite, such as the feasible print resolution of the resulting composite. It is presumed that the quantity of micropowder used in a single step is composed of microparticles comprising a distribution of particle sizes that are substantially mixed together. In these embodiments which produce a composite comprising microparticles, optional steps 320 and 330 in FIG. 4 are skipped. In step 340, the quantity of micropowder may be mixed with a binder to form a desired composite.

In some embodiments, the method may be used to produce a composite comprising nanoparticles and microparticles. Following the steps of FIG. 4, the process begins at step 310. In an exemplary process, a first quantity of nanopowder of an approximate particle size may be selected based on the desired sintering or melting temperature of the resulting composite. Said quantity of nanoparticles may be produced by plasma-based techniques. In some embodiments, the nanopowder of an approximate particle size may be selected based on a desired characteristic of the resulting composite, such as the feasible print resolution of the resulting composite. A second quantity of micropowder of an approximate particle size may be selected based on the desired sintering or melting temperature of the resulting composite 320. The desired characteristic that guides the selection of the first and second quantity of particles may be motivated by the characteristics of the resulting composite. These characteristics may be due to the effects of the combination of nanoparticles and microparticles. For example, the particle size and/or ratio of nanoparticles to microparticles in the composite may alter sintering temperature, melting temperature, and/or feasible print resolution of the composite. One of ordinary skill in the art would appreciate that numerous ratios of nanoparticles and microparticles that may be selected to achieve a desired characteristic of the resulting composite. It is presumed that the quantity of micropowder used in a step 320 is composed of microparticles comprising a distribution of particle sizes that are substantially mixed together. Said quantity of microparticles may be produced by plasma-based techniques. The second quantity of particles may be the same metal or alloy as the first quantity or can be a different metal or alloy.

At step 330, the first and second quantity of powders may be mixed to form an even dispersion of metal particles. In some embodiments, a tumbler with tumbling balls or any other mixing technique known in the arts can be used for mixing. In some embodiments, the first and second quantity of powders may be dispersed in a solvent. In some embodiments, the solvent is an organic solvent. Preferably, the first and second quantity of powders are evenly mixed.

At steps 340, a binder is added and mixed with the mixture of the first and second quantity of powder formed in step 330. Once evenly and thoroughly mixed with the binder, the composite is formed. Preferably, the resulting composite may be compatible with known printing techniques, such as silkscreen printing. Preferably, the binder is selected to out-gas or burn-off at a temperature below the bonding temperature of the composite. Preferably, the binder does not create voids in the sintered or melted metal structure. Additionally, it is desirable for the binder to be a low oxygen material to prevent oxidation of the composite powder.

In some embodiments, the first and second quantity of powders may both be nanopowders with different average particle size distributions. In some embodiments, the first and second quantity of powders may both be micropowders with different average particle size distributions.

Optionally, the product can be delivered from a manufacturer to a customer and/or user after step 310, 320, 330, or 340. In some embodiments, the metal powders, dispersed in a solvent, may be delivered after step 330. In some embodiments, the composite may be delivered after step 340.

Optionally, quality control techniques may be performed before, during, and/or after step 310, 320, 330, or 340. In some embodiments, the particle size distribution of the metal particles may be measured using techniques known in the art, such as X-ray diffraction (XRD). In some embodiments, the composite characteristics may be measured. For example, sintering temperature, melting temperature, and print resolution capabilities may be measured.

### Example

A nano-silver containing composition is prepared by mixing 900 g of alpha-terpineol, 63 g of Disperbyk-145, and 108 g of nano-silver powder. The components are stirred together, and then sonicated for 1080 minutes at a power input of 120 Watts. The sonicated mixture is centrifuged at 2000 RPM for four to five minutes. Dynamic light scattering is used to measure the size distribution of the supernatant. The supernatant is then dried down to produce the composition containing a 7% solids loading of nano-silver.

### EXEMPLARY EMBODIMENTS

The invention is further described by the following embodiments. The features of each of the embodiments are combinable with any of the other embodiments where appropriate and practical.

### Embodiment 1

A composite comprising a first population of metal nanoparticles and a binder.

### Embodiment 2

The composite of embodiment 1, further comprising a second population of metal particles, wherein said second population of metal particles is selected from the group consisting of metal microparticles and metal nanoparticles.

### Embodiment 3

The composite of embodiment 1, wherein the first population of metal nanoparticles is produced by a plasma-based technology.

### Embodiment 4

The composite of embodiment 2, wherein the second population of metal particles is produced by a plasma-based technology.

### Embodiment 5

The composite of embodiment 1 or 2, wherein the first population of metal nanoparticles is composed of a population of nanoparticles wherein about 90% of the nanoparticles have an average particle size of less than about 20 nm.

### Embodiment 6

The composite of embodiment 1 or 2, wherein the first population of metal nanoparticles is composed of a population of nanoparticles wherein about 90% of the nanoparticles have an average particle size of less than about 10 nm.

### Embodiment 7

The composite of embodiment 1 or 2, wherein the first population of metal nanoparticles is composed of a population of nanoparticles wherein about 90% of the nanoparticles have an average particle size of less than about 5 nm.

### Embodiment 8

The composite of embodiment 1 or 2, wherein the first population of metal nanoparticles is composed of a population of nanoparticles wherein about 90% of the nanoparticles have a particle size of less than about 15 nm. Embodiment 9. The composite of embodiment 2, wherein the second population of metal particles is composed of a population of microparticles.

### Embodiment 10

The composite of embodiment 9, wherein the microparticles have an average particle size of greater than 1 micron for the most abundant distribution of microparticles in the composite.

### Embodiment 11

The composite of any one of embodiments 1-10, wherein the first population of metal nanoparticles is selected from the group of copper, silver, gold, nickel, and cobalt, or an alloy of any two or more of the foregoing metals.

### Embodiment 12

The composite of any one of embodiments 1-10, wherein the first population of metal nanoparticles comprises silver.

### Embodiment 13

The composite of any one of embodiments 1-10, wherein the first population of metal nanoparticles comprises a metal alloy.

### Embodiment 14

The composite of any one of embodiments 1-10, wherein the binder decomposes at a temperature below the sintering temperature or melting temperature of the composite.

### Embodiment 15

The composite of embodiment 14, wherein the binder is substantially removed and does not leave a void or a plurality of voids in a resulting metal structure.

### Embodiment 16

A method of producing a composite comprising selecting a first population of metal nanoparticles.

### Embodiment 17

The method of embodiment 16, further comprising selecting a second population of metal particles, wherein said second population of metal particles is selected from the group consisting of metal microparticles and metal nanoparticles.

### Embodiment 18

The method of embodiment 17, comprising mixing said first and second population of metal particles.

### Embodiment 19

The method of any one of embodiments 16-18, further comprising mixing the metal particles with a binder to form a composite.

### Embodiment 20

The method of embodiment 16, wherein the first population of nanoparticles is selected from the group consisting of copper, silver, gold, nickel, and cobalt, or an alloy of any two or more of the foregoing metals.

### Embodiment 21

The method of any one of embodiments 17-19, wherein the first population of nanoparticles and the second population of metal particles are selected from the group consisting of copper, silver, gold, nickel, and cobalt, or an alloy of any two or more of the foregoing metals.

### Embodiment 22

The method of any one of embodiments 17-21, wherein the first population of nanoparticles has a particle size less than about 10 nanometers and the second population of metal particles has a particle size equal to or greater than the critical particle size for the material of the second population of metal particles.

### Embodiment 23

The method of any one of embodiments 17-21, wherein the first population of nanoparticles has a particle size less than about 10 nanometers and the second population of metal particles has a particle size of about 0.1 to 20 microns.

### Embodiment 24

The method of embodiment 23, wherein the first material and the second material are the same material.

### Embodiment 25

The method of embodiment 18, further comprising the step of mixing a binder with the mixture to form a composite, wherein the composite has substantially the same sinter temperature as the mixture.

### Embodiment 26

The method of embodiment 19 or embodiment 25, wherein the binder component of the composite decomposes at a temperature below the sinter temperature of the material.

### Embodiment 27

The method of embodiment 19 or embodiment 25, wherein the composite is a paste.

### Embodiment 28

The method of embodiment 27, wherein the paste is configured to flow into micro-mechanical aperture.

### Embodiment 29

The method of embodiment 19 or embodiment 25, wherein the composite is a printable ink.

### Embodiment 30

A method of using a composite material, comprising the step of heating the composite of any one of embodiments 1-15 to the sinter temperature such that the metal or metals of the composite material are bonded.

### Embodiment 31

The method of embodiment 30, wherein the composite has a low oxygen content such that the resulting sintered material has low electrical resistance.

The disclosures of all publications, patents, patent applications and published patent applications referred to herein by an identifying citation are hereby incorporated herein by reference in their entirety.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications can be made in the embodiments chosen for illustration without departing from the spirit and scope of the invention. Therefore, the description and examples should not be construed as limiting the scope of the invention.

What is claimed is:

1. A composition comprising:
silver nanoparticles, wherein at least about 80 mole % of the silver nanoparticles have a particle size of between about 1 nm to 15 nm, and wherein the silver nanoparticles are at least about 99% pure silver.

2. The composition of claim 1, wherein at least about 95 mole % of the silver nanoparticles have a particle size of between about 4 nm to 11 nm.

3. The composition of claim 1, wherein at least about 80 mole % of the silver nanoparticles have a particle size of between about 6 nm to 9 nm.

4. The composition of any one of claims 1-3, wherein the silver nanoparticles have a sinter temperature between about 100° C. and 250° C.

5. The composition of any one of claims 1-3, wherein the silver nanoparticles have a melting temperature between about 100° C. and 250° C.

6. The composition of any one of claims 1-5, wherein the silver nanoparticles are plasma-generated.

7. A composition comprising the silver nanoparticles of any one of claims 1-6 and a dispersant.

8. A composition comprising the silver nanoparticles of any one of claims 1-6 or the composition of claim 7, and a solvent.

9. The composition of claim 7 or claim 8, wherein the dispersant is a phosphoric ester salt of a high molecular weight copolymer.

10. The composition of claim 8, wherein the solvent is alpha-terpineol.

11. The composition of any one of claims 6-9, wherein the silver nanoparticles comprise from about 5% to about 10% by weight of the solids in the composition.

12. The composition of any one of claims 7-11, wherein the dispersant and solvent decompose, carbonize, boil off, or outgas at a temperature below the sinter temperature of the silver nanoparticles.

13. A method of making silver nanoparticles, comprising:
a) introducing silver into a plasma stream to form silver vapor; and
b) rapidly condensing the silver vapor to form solid silver metal nanoparticles;
wherein at least about 80 mole % of the silver nanoparticles have a particle size of between about 1 nm to 15 nm, and wherein the silver nanoparticles are at least about 99% pure silver.

14. The method of claim 13, wherein rapidly condensing the silver vapor is effected by injecting argon quench gas into the silver vapor at a rate of at least 2000 liters per minute.

15. The method of claim 13 or claim 14, wherein the plasma stream comprises argon that has been passed through a plasma torch.

16. The method of any one of claims 13-15, further comprising:
c) after condensing the silver vapor to form solid silver metal nanoparticles, directing the solid silver metal nanoparticles into an expanded region for additional cooling and collection.

17. The method of claim 16, wherein the expanded region is a baghouse.

18. The method of claim 17, wherein the baghouse is selected from the group consisting of a shaker baghouse, a reverse air baghouse, and a pulse jet baghouse.

19. A method of making silver paste, comprising:
mixing the silver nanoparticles of any one of claims 1-6 with a dispersant and a solvent to form a mixture comprising nanoparticles, dispersant, and solvent;
sonicating the mixture comprising nanoparticles, dispersant, and solvent;
centrifuging the mixture comprising nanoparticles, dispersant, and solvent; and
drying the supernatant of the centrifuged mixture to form silver paste.

20. The method of claim 19, further comprising, after centrifuging the mixture comprising nanoparticles, dispersant, and solvent, measuring the size distribution of the supernatant of the mixture.

21. The method of claim 20, further comprising, after centrifuging the mixture comprising nanoparticles, dispersant, and solvent, measuring the size distribution of the supernatant of the mixture with dynamic light scattering.

21. The method of claim 19 or claim 20, wherein the silver nanoparticles comprise from about 5% to about 10% by weight of the solids in the composition
